(19) United States
(12) Patent Application Publication
(10) Pub. No.: US 2010/0171714 A1
(43) Pub. Date: Jul. 8, 2010

(54) ELECTRONIC DEVICE INPUTTING CHARACTERS AND METHOD THEREOF

(75) Inventor: JUN LI, Shenzhen City (CN)

Correspondence Address: PCE INDUSTRY, INC.;ATT. Steven Reiss, 288 SOUTH MAYO AVENUE, CITY OF INDUSTRY, CA, 91789, US

(73) Assignees: SHENZHEN FUTAIHONG PRECISION INDUSTRY CO., LTD., ShenZhen City (CN); CHI MEI COMMUNICATION SYSTEMS, INC., Tu-Cheng City (TW)

(21) Appl. No.: 12/579,503

(22) Filed: Oct. 15, 2009

(30) Foreign Application Priority Data
Jan. 5, 2009 (CN) 200910300060.4

(51) Int. Cl. G06F 3/041

(52) U.S. Cl. 345/173

(57) ABSTRACT

An electronic device and method for inputting characters in an electronic device partitions the touch panel of the electronic device into a display area and one or more input areas, and sets a corresponding input method for each input area. The system and method further receives input inputted by a user on an input area, and controls other input areas to be inactive when the input area is active. Furthermore, the system and method displays the input on the display area.

### BACKGROUND

1. Technical Field

Embodiments of the present disclosure are related to electronic device management systems and methods, and particularly to an electronic device and method for inputting characters.

2. Description of Related Art

An input method is an operating system component or program that allows users to enter characters in different languages, such as Chinese, English, or Japanese, for example. Usually, each language corresponds to an input method, such as a Chinese input method, an English input method, or a Japanese input method. However, at present, input methods need to be manually selected in order to switch between different input methods. For example, to input a phrase including Chinese characters and English letters, the Chinese input method and the English input method have to be pre-selected first before inputting Chinese characters or English letters correspondingly. It is very inconvenient for user to input characters/letters and to switch between different input methods.

Therefore, there is a need for a device and method to overcome the aforementioned problem.

### BRIEF DESCRIPTION OF THE DRAWINGS

FIG. 1 is a block diagram of one embodiment of an electronic device 1 comprising a character input system.

FIG. 2 illustrates one embodiment of a touch panel of the electronic device.

FIG. 3 is a flowchart of one embodiment of a method for inputting characters into the electronic device in FIG. 1.

### DETAILED DESCRIPTION

All of the processes described below may be embodied in, and fully automated via, input method modules executed by one or more general purpose processors of an electronic device. Some or all of the methods may alternatively be embodied in specialized hardware. The input method modules may be stored in any type of computer-readable medium or other computer storage device.

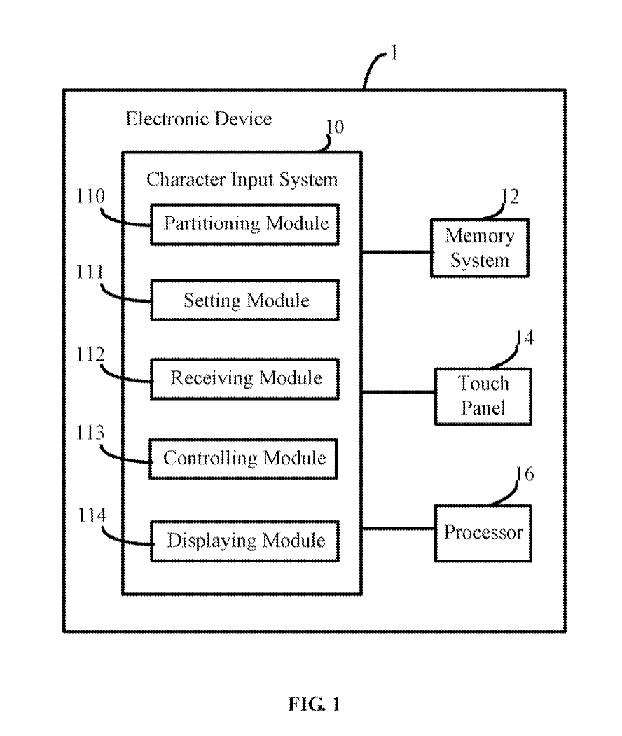

FIG. 1 is a block diagram of one embodiment of an electronic device 1 comprising a character input system 10. The character input system 10 may be used to input characters and/or letters into the electronic device 1. In one embodiment, the electronic device 1 includes a memory system 12, and a touch panel 14. The touch panel 14 may include at least one input area. In the illustrated embodiment, the touch panel 14 includes four input areas, but the disclosure is not limited thereto. Each of the four input areas is configured to recognize hand writing input of a predetermined character set. In the embodiment the four input areas may recognize, but not limited to be, Chinese characters, English letters, punctuations, and/or numbers. When one of the four input areas receives input, a corresponding one of the four input areas is invoked as an exclusive active input area. When one of the four input areas is active, the other input areas become inactive. Furthermore, the active input area remains active until another one of the four input areas receives input.

The memory system 12 may be an internal memory system card or an external memory system card, such as a smart media card (SMC), a secure digital card (SDC), a compact flash card (CFC), a multi media card (MMC), a memory system stick (MS), an extreme digital card (XDC), or a trans flash card (TFC). Depending on the embodiment, the electronic device 1 may be a mobile phone, a personal digital assistant (PDA), a handheld game player, a digital camera, or any other portable electronic device.

In one embodiment, the character input system 10 includes a partitioning module 110, a setting module 111, a receiving module 112, a controlling module 113, and a displaying module 114. One or more computerized codes of the modules 110-114 are stored in the memory system 12. One or more general purpose or specialized processors, such as a processor 16 executes the one or more computerized codes of the modules 110-114 to provide one or more operations of the electronic device 1.

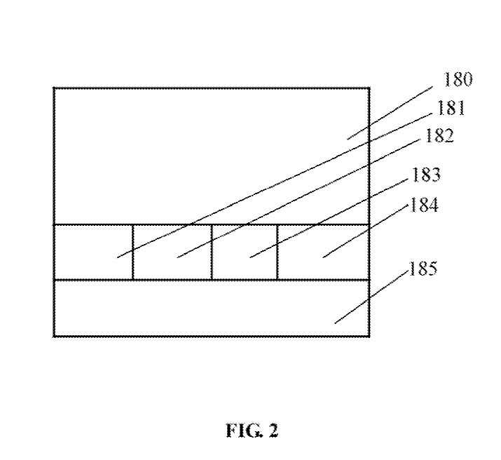

The partitioning module 110 partitions the touch panel 14 into a display area and one or more input areas. In one embodiment, as shown in FIG. 2, the partitioning module 110 partitions the touch panel 14 into the display area 180 and the input areas 181-185. The display area 180 is operable to display input inputted by a user on the input areas 181-185. As mentioned above, the input may be Chinese characters, English letters, punctuations, or numbers, for example.

The setting module 111 sets a corresponding input method for each of the input areas. The input method may include, but not limited to be, a Chinese character input method, an English letter input method, a punctuation input method, and/or a number input method, for example. In one embodiment, the input areas include a Chinese character input area, an English letter input area, a punctuation input area, a number input area, and other character input area correspondingly. For example, the input area 181 may be used to input Chinese characters, the input area 182 may be used to input English letters, the input area 183 may be used to input numbers, the input area 184 may be used to input punctuations, and the input area 185 may be used to input other predetermined characters, such as Japanese characters, for example.

The receiving module 112 receives input inputted by a user on an input area correspondingly, wherein the input area is active and the input corresponds to characters of the corresponding input method for the input area. In one embodiment, if English letters are inputted on the input area 182, then the receiving module 112 receives the English letters. The user may input the characters using a light pen, a stylus, or hand writing on the touch panel 14, but the disclosure is not limited thereto.

The controlling module 113 controls the other input areas to be inactive when the input area is active. In one embodiment, as shown in FIG. 2, if the input area 182 is receiving English letters, the input area 182 is invoked as the active input area exclusively, then the input areas 181, 183, 184, 185 cannot be allowed to input characters simultaneously, for example.

The displaying module 114 displays the inputted characters on the display area 180. In one embodiment, as shown in FIG. 2, the displaying module 114 displays the English letters on the display area 180, such as “I am here,” for example.

The receiving module 112 further determines if the input area receives other characters inputted by the user.

The receiving module 112 determines if one of the other input areas is active.

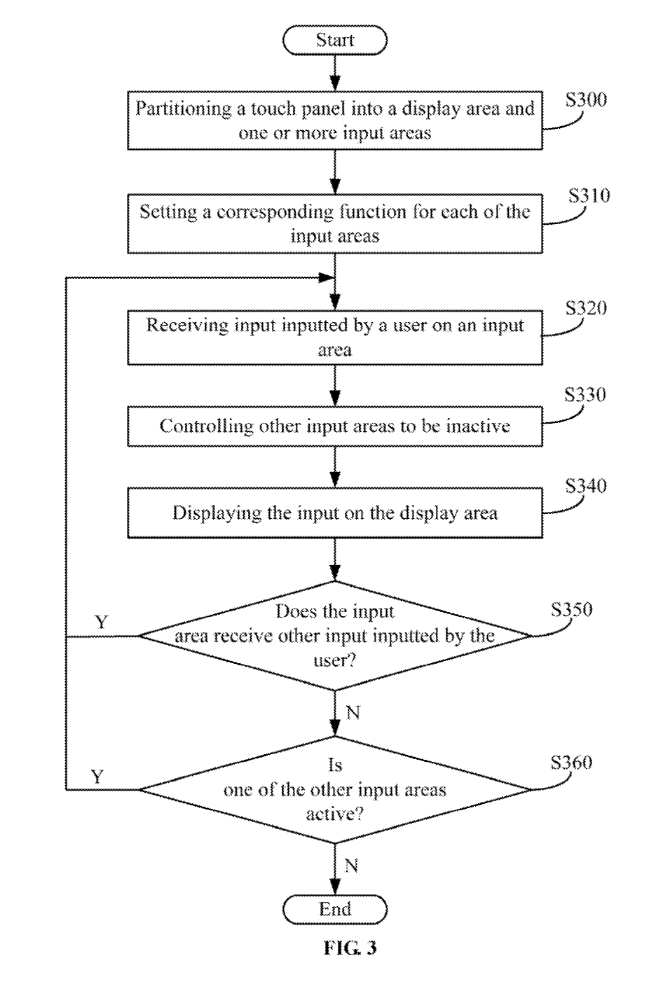

FIG. 3 is a flowchart of one embodiment of a method for inputting characters into the electronic device 1. Depending on the embodiment, additional blocks may be added, while others deleted, and the blocks may also be executed in a different order than described.

In block S300, the partitioning module 110 partitions the touch panel 14 into a display area and one or more input areas. As mentioned above, as shown in FIG. 2, the partitioning module 110 partitions the touch panel 14 into the display area 180 and the input areas 181-185. The display area 180 is operable to display input by a user on the input areas 181-185, the input may be Chinese characters, English letters, punctuations, or numbers, for example.

In block S310, the setting module 111 sets a corresponding input method for each of the input areas. The input method includes, but not limited to be, a Chinese character input method, an English letter input method, a punctuation input method, and a number input method, for example.

In block S320, the receiving module 112 receives input inputted by a user on an input area, wherein the input area is active and the input corresponds to characters of the corresponding input method for the input area. In one embodiment, if the input area is active and the user inputs English letters “I am here” on the input area 182, then the receiving module 112 receives “I am here” from the input area 182. The user inputs the letters “I am here” using a light pen, a stylus, or hand writing on the touch panel 14, but the disclosure is not limited thereto.

In block S330, the controlling module 113 controls the other input areas to be inactive when the input area is active. As mentioned above, as shown in FIG. 2, if the user inputs English letters on the input area 182, then the input area 181 cannot be allowed to input Chinese characters, for example.

In block S340, the displaying module 114 displays the input on the display area 180. As mentioned above, as shown in FIG. 2, the displaying module 114 displays the English letters on the display area 180, such as “I am here,” for example.

In block S350, the receiving module 112 further determines if the input area receives other input inputted by the user. In one embodiment, if the user continues inputting English letters on the input area 182, then the procedure goes to block S320. Otherwise, if the user stops inputting English letters on the input area 182, then the procedure goes to block S360.

In block S360, the receiving module 112 determines if one of the other input areas is active. In one embodiment, if another input area (e.g., the Chinese character input area) is active for inputting characters, then the procedure goes to block S320. Otherwise, the procedure ends.

Although certain inventive embodiments of the present disclosure have been specifically described, the present disclosure is not to be construed as being limited thereto. Various changes or modifications may be made to the present disclosure without departing from the scope and spirit of the present disclosure.

What is claimed is:

1. An electronic device, comprising:
a memory system storing a plurality of programs;
and a processor that executes one or more operations for the plurality of programs, the plurality of programs comprising:
a partitioning module operable to partition a touch panel of the electronic device into a display area and one or more input areas;
a setting module operable to set a corresponding input method for each of the input areas.;
a receiving module operable to receive input inputted by a user on an input area, causing the input area to become active, wherein the input corresponds to characters of the corresponding input method for the input area;
a controlling module operable to control other input areas to be inactive when the input area is active; and
a displaying module operable to display the input on the display area.

2. The electronic device of claim 1, wherein the input method is selected from the group consisting of a Chinese input method, an English input method, a punctuation input method, and a number input method.

3. The electronic device of claim 1, wherein the input areas comprise a Chinese character input area.

4. The electronic device of claim 1, wherein the input areas comprise an English letter input area.

5. The electronic device of claim 1, wherein the input areas comprise a punctuation input area.

6. The electronic device of claim 1, wherein the input areas comprise a number input area.

7. The electronic device of claim 1, wherein the electronic device is selected from the group consisting of a mobile phone, a personal digital assistant (PDA), a handheld game player, and a digital camera

8. A method for inputting characters in an electronic device, the method comprising:
partitioning a touch panel of the electronic device into a display area and one or more input areas;
setting a corresponding input method for each of the input areas;
receiving input inputted by a user on an input area, causing the input area to become active, wherein the input corresponds to characters of the corresponding input method for the input area;
controlling other input areas to be inactive when the input area is active; and
displaying the input on the display area.

9. The method of claim 8, wherein the input method is selected from the group consisting of a Chinese input method, an English input method, a punctuation input method, and a number input method.

10. The method of claim 8, wherein the input areas comprise a Chinese character input area.

11. The method of claim 8, wherein the input areas comprise an English letter input area.

12. The method of claim 8, wherein the input areas comprise a punctuation input area.

13. The method of claim 8, wherein the input areas comprise a number input area.

14. The method of claim 8, wherein the electronic device is selected from the group consisting of a mobile phone, a personal digital assistant (PDA), a handheld game player, and a digital camera.

15. A storage medium having stored thereon instructions that, when executed by an electronic device, causes the electronic device to perform a method for inputting characters in an electronic device, the method comprising:
partitioning a touch panel of the electronic device into a display area and one or more input areas;
setting a corresponding input method for each of the input areas;
receiving input inputted by a user on an input area, causing the input area to become active, wherein the input corresponds to characters of the corresponding input method for the input area;
controlling other input areas to be inactive when the input area is active; and
displaying the input on the display area.

16. The medium of claim 15, wherein the input method is selected from the group consisting of a Chinese input method, an English input method, a punctuation input method, and a number input method.

17. The medium of claim 15, wherein the input areas comprise a Chinese character input area.

18. The medium of claim 15, wherein the input areas comprise an English letter input area.

19. The medium of claim 15, wherein the input areas comprise a punctuation input area.

20. The medium of claim 15, wherein the input areas comprise a number input area.
